(19) United States
(12) Patent Application Publication
(10) Pub. No.: US 2025/0192198 A1
(43) Pub. Date: Jun. 12, 2025

(54) EJECTOR FOR FUEL CELL AND FUEL CELL

(71) Applicant: SCHAEFFLER TECHNOLOGIES AG & CO. KG, Herzogenaurach (DE)

(72) Inventors: Bingchun Yang, Shanghai (CN); Min ZHANG, Shanghai (CN); Pengfei LI, Shanghai (CN); Xu Han, Shanghai (CN); Qiushan MA, Wuxi (CN); Qingfeng YU, Shanghai (CN)

(21) Appl. No.: 18/279,653

(22) PCT Filed: Mar. 1, 2021
(86) PCT No.: PCT/CN2021/078484

§ 371 Date: Sep. 1, 2023

(51) Int. Cl. H01M 8/04089; F04F 5/46; H01M 8/0438

(52) U.S. Cl. CPC H01M 8/04097; F04F 5/461; H01M 8/04402; H01M 8/04425; H01M 2250/20

(57) ABSTRACT

An ejector for a fuel cell includes a housing, a nozzle, and an adjusting device. The housing includes a Venturi section, a first inlet through which new fuel gas is communicated into the housing, and a second inlet through which is recycled fuel gas is communicated into the housing. The nozzle is located inside the housing and fixed to the housing. The nozzle includes a tapered portion extending into the Venturi section. The adjusting device includes an adjusting element extending into the nozzle, wherein the adjusting element is configured to be located at different axial positions, and a cross-sectional area of at least a part of a first passage formed inside the nozzle is different when the adjusting element is located at the different axial positions.

### CROSS-REFERENCE TO RELATED APPLICATIONS

This application is the U.S. National Phase of PCT Appln. No. PCT/CN2021/078484 filed Mar. 1, 2021, the entire disclosure of which is incorporated by reference herein.

### TECHNICAL FIELD

The present disclosure relates to the field of fuel cell, and in particular to an ejector for a fuel cell and a fuel cell including such ejector.

### BACKGROUND

Nowadays, fuel cells have been used in powertrains of vehicles. For example, in a fuel cell that uses hydrogen as fuel gas, a hydrogen supply system is usually used in conjunction with an ejector to control flow rate of new hydrogen flow and flow rate of recycled hydrogen flow. Generally, an ejector with Venturi suction function is used to achieve the above function. In this case, the ejector delivers the recycled hydrogen flow from the fuel cell and the new hydrogen flow to the fuel cell. Venturi tube is used to achieve flow rate control during the delivery. In order to ensure the suction function of the Venturi tube for the recycled hydrogen flow when the fuel cell is just starting to work (that is, when the flow rate of the new hydrogen flow entering into the fuel cell is low), a cross-sectional area of at least a part of the contraction section of the Venturi tube should be controlled as required.

However, in prior arts, to solve the above problems, some ejectors have poor operating stability due to stepless adjustments based on pressure of the contraction section, and/or some ejectors have a complicated structure to achieve the above suction function.

### SUMMARY

The present disclosure is made with reference to the above-mentioned defects of the prior arts. The present disclosure, according to exemplary embodiments, provides an ejector for a fuel cell, in which a good suction effect for recycled fuel gas is ensured when a flow rate of new fuel gas is low, the ejector has a simple structure and good operating stability. The present disclosure further provides a fuel cell including the above-mentioned ejector.

This disclosure provides an ejector for a fuel cell, comprising:
a housing, including a Venturi section formed with a contraction section, a throat section and a diffusion section that are sequentially arranged and in communication from one side to the other side of the Venturi section in an axial direction of the housing, the housing also including a first inlet through which new fuel gas is communicated into the housing and a second inlet through which recycled fuel gas is communicated into the housing:
a nozzle, which is located inside the housing and is fixed to the housing, the nozzle having a tapered portion extending into the contraction section, the tapered portion and the contraction section being in shape-fit and spaced apart from each other in a radial direction of the housing, and a first passage being formed inside the nozzle, a second passage being formed between the nozzle and the contraction section, wherein the first inlet is in communication with the throat section via the first passage, and the second inlet is in communication with the throat section via the second passage: and
an adjusting device, which is at least partially located inside the housing and is located at one side of the nozzle in the axial direction, the adjusting device including an adjusting element extending into the nozzle, wherein the adjusting element is configured to be located at different axial positions, and a cross-sectional area of at least a part of the first passage is different when the adjusting element is located at the different axial positions.

In embodiments, the adjusting element has a tip formed in a tapered shape, an axial length of the tip extending into the nozzle is different when the adjusting element is located at the different axial positions.

In embodiments, the adjusting device further includes a positioning sleeve located inside the housing and fixed to the housing, wherein the positioning sleeve includes positioning portions corresponding to the different axial positions, and the adjusting element includes positioned portions that are engageable with the positioning portions, so that when the positioned portions are engaged with the positioning portions, the adjusting element is located at corresponding axial positions.

In embodiments, an axial end of the positioning sleeve facing the nozzle includes a plurality of first guide surfaces extending in a circumferential direction of the positioning sleeve, wherein the positioning portions are provided at circumferential ends of the first guide surfaces or at either side in the circumferential direction relative to the first guide surfaces, and wherein the positioning portions have first positioning portions and second positioning portions alternately arranged in the circumferential direction, so that the positioned portions are configured to be guided by the first guide surfaces to engage with the first positioning portions or the second positioning portions.

In embodiments, the adjusting device further includes an elastic element and a cam sleeve, wherein one end of the elastic element abuts against the housing or the nozzle, and another end of the elastic element abuts against the adjusting element, so that the elastic element exerts elastic force on the adjusting element, wherein an axial end of the cam sleeve facing the nozzle includes a plurality of second guide surfaces extending in the circumferential direction, wherein the cam sleeve is movable relative to the positioning sleeve in the axial direction, so that the cam sleeve is movable against the positioned portions to corresponding axial positions where the second guide surfaces and the first guide surfaces are aligned or the second guide surfaces are closer to the nozzle relative to the first guide surfaces, wherein after being disengaged from the first positioning portions, the positioned portions are configured to rotate relative to the positioning portions and are guided to the first guide surfaces corresponding to the second positioning portions under the elastic force.

In embodiments, axial ends of the positioned portions away from the nozzle have guided surfaces which are in shape-fit with the first guide surfaces and the second guide surfaces.

In embodiments, the adjustment element further includes an inner cylinder extending into the cam sleeve, so that the adjusting element is supported by the cam sleeve.

In embodiments, the cam sleeve is fixed relative to the positioning sleeve in a circumferential direction of the housing.

In embodiments, the ejector further includes an actuator, which is able to exert a force on the cam sleeve in the axial direction, so that the adjustment element is pushed by the cam sleeve to move against the elastic force.

This disclosure further provides a fuel cell comprising the ejector for fuel cell according to any one of the above-mentioned solutions.

In embodiments, wherein,
when a flow rate of a fuel gas flow passing through the first inlet of the ejector for the fuel cell is less than a predetermined value, the adjusting element of the adjusting device of the ejector for the fuel cell is located at a first axial position,
when the flow rate of the fuel gas flow passing through the first inlet of the ejector for the fuel cell is greater than or equal to the predetermined value, the adjusting element is located at another axial position different from the first axial position,
when the adjusting element is located at the first axial position, the cross-sectional area of at least a part of the first passage is minimized by the adjusting element.

Upon the above technical solutions, the present disclosure provides an ejector for a fuel cell for supplying both new or fresh fuel gas from outside of the fuel cell and recycled fuel gas from the fuel cell into the fuel cell. The ejector includes a housing, a nozzle and an adjusting device assembled together. The housing includes a Venturi section, wherein the Venturi section is formed with a contraction section, a throat section and a diffusion section that are sequentially arranged and communicated from one side to the other side of the Venturi section in the axial direction of the housing. The housing also includes a first inlet through which the new fuel gas flows into the housing and a second inlet through which the recycled fuel gas from the fuel cell flows into the housing. The nozzle is located inside the housing and is fixed to the housing. The nozzle includes a tapered portion extending into the contraction section, the tapered portion and the contraction section are in shape-fit and spaced apart from each other in the radial direction of the housing. A first passage is formed inside the nozzle, and a second passage is formed between the nozzle and the tapered section. The first inlet is in communication with the throat section through the first passage, and the second inlet in communication with the throat section through the second passage. The adjusting device is at least partially located inside the housing, the adjusting device is located at one side in the axial direction relative to the nozzle. The adjusting device includes an adjusting element extending into the nozzle. The adjusting element is configured to be located at different axial positions. The cross-sectional area of at least a part of the first passage is different when the adjusting element is located at different axial positions.

In this way, in the ejector of the present disclosure, the size of the passage through which the new fuel gas flows into the Venturi section could be controlled by a simple and practical adjusting device, even if the flow rate of the new fuel gas is low, the sufficient suction performance for the recycled fuel gas from the fuel cell is ensured. The adjusting element of the ejector is configured to be located at discrete and different axial positions, thereby the operating stability of the ejector is good and the service life of the ejector is longer.

### BRIEF INTRODUCTION TO THE DRAWINGS

FIG. 1 is a schematic cross-sectional view showing an ejector for a fuel cell according to an embodiment of the present disclosure.

FIG. 2 is an exploded schematic view showing the adjusting device of the ejector for the fuel cell in FIG. 1, in FIG. 2 the cross-sectional structure of each component is shown, and the section lines are omitted.

FIG. 3A is a schematic cross-sectional view for explaining the first operating state of the ejector for the fuel cell in FIG. 1, in FIG. 3A an adjusting element is located at a first axial position, and the section lines are omitted.

FIG. 3B is a schematic view for explaining the relationship between the adjusting element, a positioning sleeve and an elastic element when the ejector for the fuel cell in FIG. 1 is in the first operating state.

FIG. 4A is a schematic cross-sectional view for explaining the second operating state of the ejector for the fuel cell in FIG. 1, in FIG. 4A the adjusting element is located at a second axial position, and the section lines are omitted.

FIG. 4B is a schematic view for explaining the relationship between the adjusting element, the positioning sleeve and the elastic element when the ejector for the fuel cell in FIG. 1 is in a second operating state.

FIG. 5 is a graph for explaining the relationship between a fuel gas entrainment ratio and a current density of the fuel cell including the ejector in FIG. 1, in FIG. 5 the ordinate indicates the fuel gas entrainment ratio and the abscissa indicates the current density.

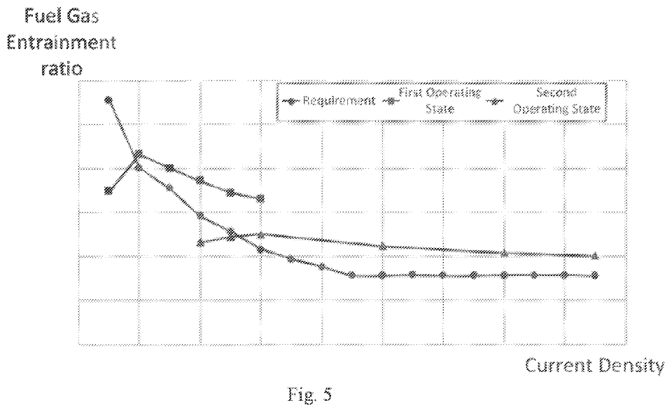

### TERM LIST

1 housing
1h1 first inlet
1h2 second inlet
1h3 outlet
11 Venturi section
111 contraction section
112 throat section
113 diffusion section
12 mount section
2 nozzle
21 base portion
22 tapered portion
3 adjusting device
31 adjusting element
31p tip
311 needle-shaped portion
312 flange
313 inner cylinder
314 positioned portion
314s guided surface
32 positioning sleeve
32s first guide surface
32c1 first positioning portion
32c2 second positioning portion
33 elastic element
34 cam sleeve
34s second guide surface
4 actuator
m1 first gas flow
m2 second gas flow
p1 first passage
p2 second passage
A axial direction
R radial direction

### DETAILED DESCRIPTION

Exemplary embodiments of the present disclosure will be described below with reference to the drawings. It should be understood that these specific descriptions are only intended to teach those skilled in the art how to practice the present disclosure, and are not intended to be exhaustive of all possible ways of carrying out the present disclosure or to limit the scope of the present disclosure.

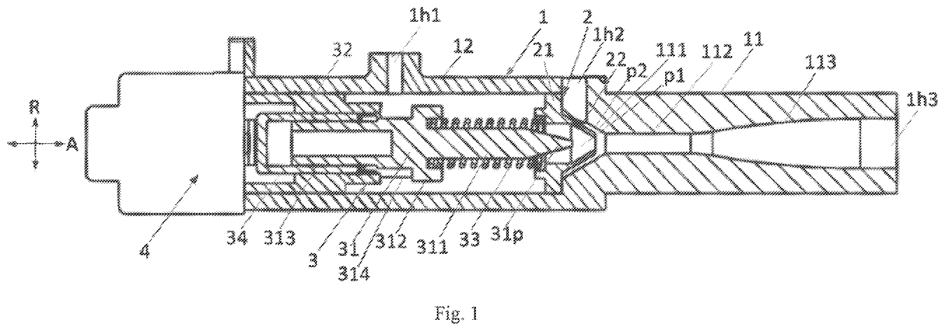

In this disclosure, unless otherwise specified, “axial direction”, “radial direction” and “circumferential direction” refer to the axial direction, radial direction and circumferential direction of the housing of the ejector respectively: “one side in the axial direction” refers to the left side in FIGS. 1, 3A, 3B, 4A, and 4B, and “the other side in the axial direction” refers to the right side in FIGS. 1, 3A, 3B, 4A, and 4B: “outer side in the radial direction” refers to the side away from the center axis of the housing in the radial direction, “inner side in the radial direction” refers to the side close to the center axis of the housing in the radial direction: “one side in the circumferential direction” refers to the downstream side in the counterclockwise direction when viewed from the other side toward one side in the axial direction, and “the other side in the circumferential direction” refers to the downstream side in the clockwise direction when viewed from the other side toward one side in the axial direction.

The structure of an ejector for a fuel cell according to an exemplary embodiment of the present disclosure will be described below with reference to the drawings.

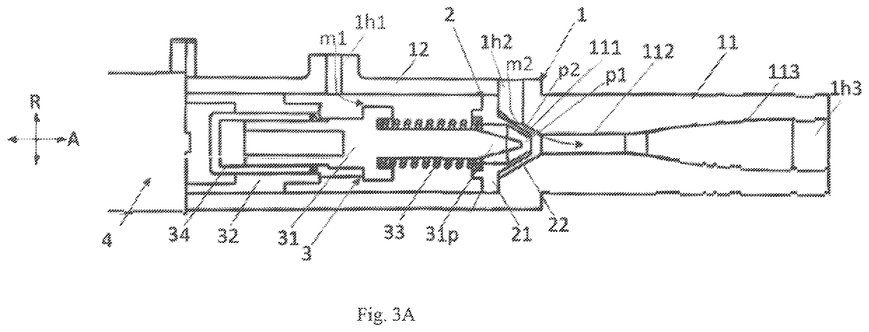

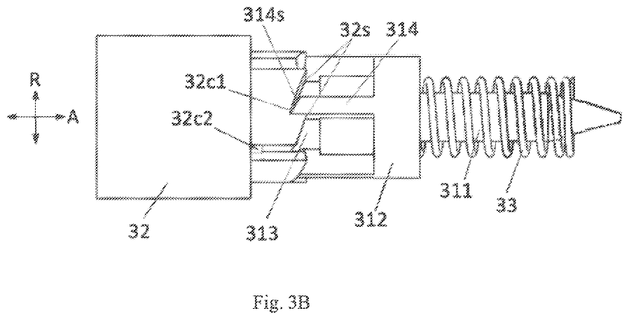

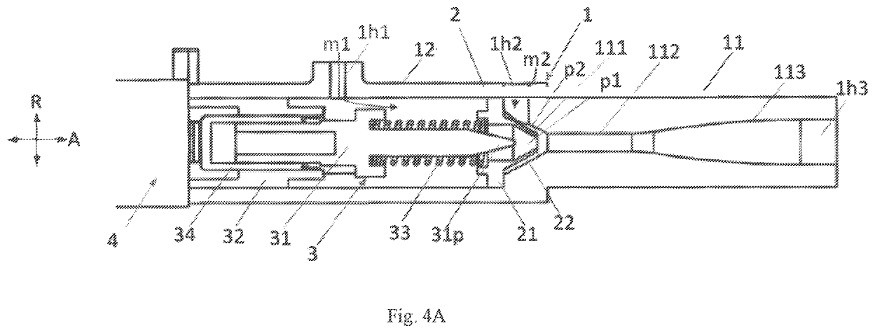

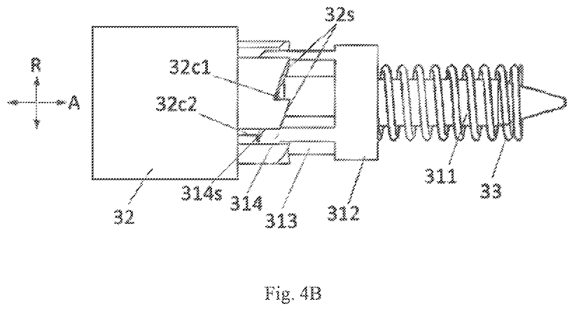

For example, referring to FIGS. 3A and 4A, the ejector for the fuel cell according to an exemplary embodiment of the present disclosure is used to simultaneously deliver a first gas flow m1 and a second gas flow m2 into the fuel cell. The first gas flow m1 may be new or fresh fuel gas from outside of the fuel cell, and the second gas flow m2 may be recycled fuel gas from the fuel cell. An example of the fuel gas is hydrogen, but is not limited to hydrogen.

As shown in FIGS. 1 to 4B, the ejector for the fuel cell according to an exemplary embodiment of the present disclosure comprises a housing 1, a nozzle 2, an adjusting device 3 and an actuator 4 assembled together.

In this exemplary embodiment, a housing 1 is formed with a cavity penetrating from one side to the other side in the axial direction A, wherein the cavity has a circular cross section at any axial location of the housing 1. The housing 1 includes two functional sections, namely a Venturi section 11 and a mount section 12. The Venturi section 11 includes a contraction section 111, a throat section 112 and a diffusion section 113 that are sequentially arranged and in communication from one side to the other side of the Venturi section 11 in the axial direction A. A nozzle 2 and a adjusting device 3 are mounted in the cavity corresponding to the mount section 12, and the mount section 12 is located at one side of the Venturi section 11 in the axial direction A.

The housing 1 includes a first inlet 1h1, a second inlet 1h2 and an outlet 1h3. The first inlet 1h1 is formed in the mount section 12 and penetrates a wall of the mount section 12 in the radial direction R. The first gas flow m1 could flow into the cavity inside the mount section 12 via the first inlet 1h1. The second inlet 1h2 is formed in the Venturi section 11, penetrates a wall of the Venturi section 11 in the radial direction R, and communicates with the contraction section 111. The second gas flow m2 could flow into the cavity inside the Venturi section 11 via the second inlet 1h2. The outlet 1h3 is formed at the other side end in the axial direction A of the housing 1 and communicates with the diffusion section 113. The first gas flow m1 and the second gas flow m2 could flow out of the diffusion section 113 via the outlet 1h3.

In this exemplary embodiment, the nozzle 2 is located in the cavity inside the housing 1 and is fixed to the housing 1. The nozzle 2 includes a base portion 21 and a tapered portion 22 formed as one piece. The base portion 21 is fixed to the other side end in the axial direction A of the mount section 12 by interference fit, for example. The tapered portion 22 extends from the base portion 21 toward the other side in the axial direction A and extends into the contraction section 111 of the Venturi section 11. The tapered portion 22 and the contraction section 111 are in shape-fit and are spaced apart from each other in the radial direction R. In addition, the nozzle 2 includes a through hole extending in the axial direction A, through which the cavity inside the mount section 12 communicates with the Venturi section 11. The through hole is formed as a straight hole with a constant cross-sectional area in the base portion 21, and the through hole is formed as a tapered hole of which the cross-sectional area gradually decreases toward the other side in the axial direction in the tapered portion 22. In this way, the through hole inside the nozzle 2 is formed as a first passage p1, and the first inlet 1h1 communicates with the throat section 112 through the first passage p1: a second passage p2 is formed between the nozzle 2 and the contraction section 111, and the second inlet 1h2 communicates with the throat section 112 through the second passage p2. The second passage p2 may be formed as a tapered shape that tapers in the axial direction A.

In this exemplary embodiment, the size (mainly the cross-sectional area) of the first passage p1 could be adjusted by the adjusting device 3 as required. The adjusting device 3 is at least partially located inside the housing 1, and the adjusting device 3 is located at one side of the nozzle 2 in the axial direction A. The adjusting device 3 includes an adjusting element 31 extending into the nozzle 2. The adjusting element 31 has a tip 31p that is in shape-fit with the tapered portion 22, and the tip 31p is formed in a shape that tapers toward the other side in the axial direction. The adjusting element 31 could be located at a first axial position (as shown in FIGS. 3A and 3B) and a second axial position (as shown in FIGS. 4A and 4B) under control. In the two axial positions, an axial length of the tip 31p extending into the tapered portion 22 is different. In this way, when the adjusting element 31 is located at the two axial positions, the cross-sectional area of the first passage p1 is different, thereby the flow velocity of the first gas flow m1 flowing through the first passage p1 is adjusted. In addition to the adjusting element 31, the adjusting device 3 also includes a positioning sleeve 32, an elastic element 33 and a cam sleeve 34 which are assembled with the adjusting element 31. The adjusting element 31, the positioning sleeve 32, the elastic element 33 and the cam sleeve 34 are coaxially assembled together relative to the housing 1. The positioning sleeve 32, the elastic element 33, and the cam sleeve 34 are used to move the adjusting element 31 to the first axial position or the second axial position, and to maintain the adjusting element 31 at the corresponding axial position.

Specifically, the adjusting element 31 comprises a needle-shaped portion 311, a flange 312, an inner cylinder 313 and a plurality of positioned portions 314 formed as one piece. The needle-shaped portion 311, the flange 312 and the inner cylinder 313 are arranged coaxially.

The adjusting element 31 linearly extends along the axial direction A, the tip 31p of the adjusting element 31 is formed at the other side end in the axial direction A of the needle-shaped portion 311, and the one side end in the axial direction A of the needle-shaped portion 311 and the flange 312 is connected.

The flange 312 is located between the needle-shaped portion 311 and the inner cylinder 313. The outer diameter of the flange 312 is larger than the outer diameter of the needle-shaped portion 311 and the outer diameter of the inner cylinder 313. The flange 312 is formed with a ring-shaped recess against which the one side end in the axial direction A of the elastic element 33 abuts and which limits the one side end in the axial direction A of the elastic element 33.

The other end in the axial direction A of the inner cylinder 313 is connected to the flange 312, and a part of the inner cylinder 313 including the one side end in the axial direction A is inserted into the cam sleeve 34, so that the inner cylinder 313 could be supported by the cam sleeve 34, so as to prevent the adjustment element 31 from being skewed relative to the axial direction A.

The positioned portions 314 are formed as ribs located at the outer side of the inner cylinder 313 in the radial direction R and linearly extending along the axial direction A, and a plurality of positioned portions 314 are evenly distributed in the circumferential direction. A guided surface 314s (as shown in FIGS. 3B and 4B) extending along the circumferential direction is formed on one side end in the axial direction A of each positioned portion 314. The guided surface 314s extends toward the one side in the circumferential direction while obliquely extending toward the one side in the axial direction A. The guided surface 314s is in shape-fit with the first guide surface 32s of the positioning sleeve 32 and the second guide surface 34s of the cam sleeve 34, so that the first guide surface 32s, the second guide surface 34s and the guided surface 314s are in shape-fit to guide the positioned portion 314 to the corresponding a first positioning portion 32c1 or a second positioning portion 32c2.

Furthermore, the positioning sleeve 32 is located inside the housing 1 and is fixed to the housing 1. The positioning sleeve 32 is formed with the first positioning portions 32c1 corresponding to the first axial position and the second positioning portions 32c2 corresponding to the second axial position. In this embodiment, the first positioning portion 32c1 and the second positioning portion 32c2 are positioning grooves having different depths in the axial direction A.

The other side end in the axial direction A of the positioning sleeve 32 is formed with a plurality of first guide surfaces 32s extending along the circumferential direction, the plurality of first guide surfaces 32s are evenly distributed in the circumferential direction, and each of the first guide surfaces 32s extends toward the one side in the circumferential direction while obliquely extending toward the one side in the axial direction A. As described above, the first guide surface 32s is in shape-fit with the guided surface 314s of the positioned portion 314. The first positioning portion 32c1 is provided at the one side end in the circumferential direction of the corresponding first guide surface 32s, and the second positioning portion 32c2 is provided at the one side in the circumferential direction relative to the one side end in the circumferential direction of the corresponding first guide surface 32s. The first positioning portions 32c1 and the second positioning portions 32c2 are alternately arranged in the circumferential direction, so that the positioned portion 314 could be guided by the first guide surface 32s to engage with the first positioning portion 32c1 or the second positioning portion 32c2.

Furthermore, the elastic element 33 is a cylindrical coil spring, and the elastic element 33 is sleeved on the needle-shaped portion 311 of the adjusting element 31. The one side end in the axial direction A of the elastic element 33 abuts against the flange 312 of the adjusting element 31, and the other end in the axial direction A of the elastic element 33 abuts against the base portion 21 of the nozzle 2, so that when the elastic element 33 is compressed, an elastic force (spring force) toward the one side in the axial direction is exerted on the adjustment element 31.

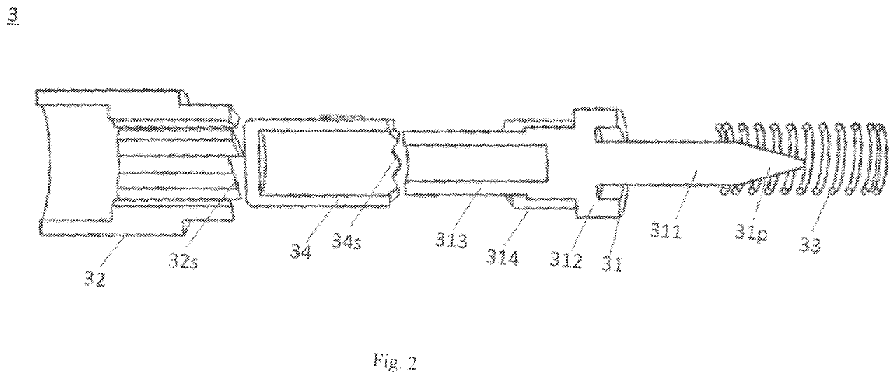

Furthermore, the cam sleeve 34 is fixed relative to the positioning sleeve 32 in the circumferential direction, but the cam sleeve 34 can reciprocate relative to the positioning sleeve 32 in the axial direction A. The other side end in the axial direction A of the cam sleeve 34 is formed with a plurality of second guide surfaces 34s (as shown in FIG. 2) extending in the circumferential direction, and the plurality of second guide surfaces 34s are evenly distributed in the circumferential direction. The second guide surfaces 34s and the corresponding first guide surfaces 32s are offset by a predetermined angle in the circumferential direction. Under the action of the axial force of the actuator 4, the cam sleeve 34 could abut against the positioned portion 314 of the adjusting element 31, so that the second guide surface 34s abuts against the guided surface 314s. In this abutting state, the cam sleeve 34 moves to align the second guide surface 34s with the first guide surface 32s or such that the second guide surface 34s is located at the other side in the axial direction A relative to the first guide surface 32s, thereby the positioned portion 314 and the first positioning portion 32c1 or the second positioning portion 32c2 are disengaged. Thereafter, the guided surface 314s slides along the second guide surface 34s, and the guided surface 314s moves relative to the second guide surface 34s in the circumferential direction. The positioned portion 314 is guided to the corresponding first guide surface 32s under the action of the elastic force of the elastic element 33, after the axial force of the actuator 4 is removed, and the positioning portion 314 is guided by the first guide surface 32s, the positioning portion 314 finally engages with the second positioning portion 32c2 or the first positioning portion 32c1.

In this exemplary embodiment, the actuator 4 may be, for example, a solenoid valve. The actuator 4 could exert an axial force toward the other side in the axial direction on the cam sleeve 34 under control, so that the adjustment element 31 is pushed to a predetermined position at the other side in the axial direction against the elastic force of the elastic element 33 by the cam sleeve 34, thereby the second guide surface 34s and the first guide surface 32s are aligned or the second guide surface 34s is located slightly at the other side in the axial direction relative to the first guide surface 32s.

The operation of the above ejector for fuel cell will be described below.

When the fuel cell including the above ejector is started, since the flow rate of the first gas flow m1 entering from the first inlet 1h1 is low, in order to ensure the suction intensity for the second gas flow m2 entering from the second inlet 1h2, the ejector is in the first operating state shown in FIGS. 3A and 3B. At this time, in the adjusting device 3, the positioned portion 314 of the adjustment element 31 is engaged with the first positioning portion 32c1 of the positioning sleeve 32, so that the adjustment element 31 is located at the first axial position. The length of the other side end in the axial direction (the tip 31p) of the adjustment element 31 projecting into the nozzle 2 is larger, thereby the cross-sectional area of a part of the first passage p1 becomes smaller. In this way, even if the flow rate of the first gas flow m1 from the first inlet 1h1 is low, a higher flow velocity when the first gas flow m1 passes through the first passage p1 is obtained, so that large negative pressure is generated at the location of the contraction section 111 connected to the throat section 112, which ensures the suction intensity of the second gas flow m2.

After the fuel cell including the above-mentioned ejector goes into the normal operation state, since the flow rate of the first gas flow m1 entering from the first inlet 1h1 becomes larger, there is no need to reduce the cross-sectional area of the first passage p1 as described above. At this time, the actuator 4 exerts an axial force on the cam sleeve 34 of the adjusting device 3 toward the other side in the axial direction A, against the elastic force of the elastic element 33, so that the cam sleeve 34 moves toward the other side in the axial direction A in the state of abutting against the adjusting element 31. After the second guide surface 34s of the cam sleeve 34 is aligned with the first guide surface 32s of the positioning sleeve 32, via the shape-fit of the first guide surface 32s, the second guide surface 34s and the guided surface 314s of the adjusting element 31, under the action of the elastic force, the adjusting element 31 rotates toward the one side in the circumferential direction, and the guided surface 314s fits with the first guiding surface 32s. After the axial force of the actuator 4 is removed, the positioned portion 314 is guided by the first guide surface 32s to the corresponding second positioning portion 32c2, the positioned portion 314 and the second positioning portion 32c2 of the positioning sleeve 32 are engaged so that the adjustment element 31 is maintained in the second axial position. In this way, the ejector is maintained in the second operating state shown in FIGS. 4A and 4B, and the length of the other side end in the axial direction (tip 31p) of the adjusting element 31 protruding into the nozzle 2 is smaller, so that the cross-sectional area of the corresponding part of the first passage p1 becomes larger. In this way, the first passage p1 satisfies the requirement of the first gas flow m1 with a large flow rate from the first inlet 1h1, and does not adversely affect the suction performance of the second gas flow m2.

The present disclosure also provides a fuel cell comprising the ejector for the fuel cell described above. Each operating point (current density) of the fuel cell corresponds to a specific requirement of hydrogen entrainment ratio. At the operating point of low current density, the requirement of hydrogen entrainment ratio is higher, the ejector is in the first operating state, and the suction performance for the second gas flow m2 under the condition that the flow rate of the first gas flow m1 is low is improved. At the operating point of high current density, the hydrogen entrainment ratio is lower than the requirement, and the ejector is in the second operating state to allow the new first gas flow m1 with a larger flow rate.

The present disclosure is not limited to the above-mentioned embodiments, and those skilled in the art can make various modifications to the above-mentioned embodiments of the present disclosure under the teaching of the present disclosure without departing from the scope of the present disclosure. In addition, the following description will be given.

(i) Although in the ejector for fuel cell according to an embodiment of the present disclosure described in the detailed embodiments, the adjustment element 31 of the adjusting device 3 could be located at two different axial positions, where the cross-sectional area of a part of the first passage p1 is different when the adjustment element 31 is located at the two axial positions, but the present disclosure is not limited to this. The number of different axial positions where the adjusting element 31 could be located should be any as required, and the cross-sectional area of at least a part of the first passage p1 is different when the adjusting element 31 is located at every two different axial positions.

In order to realize this solution, the same number of positioning portions could be provided corresponding to different axial positions, and these positioning portions are arranged periodically alternately in the circumferential direction, so as to realize that the adjusting element is located at different axial positions.

(ii) It should be understood that as long as the actuator 4 is actuated once, one operating state transition of the ejector is realized. Taking the ejector described in the above detailed embodiment as an example, in the initial state, the positioned portion 314 of the adjusting element 31 is engaged with the first positioning portion 32c1 of the positioning sleeve 32, and the ejector maintains in the first operating state. After the actuator 4 is actuated once, the positioned portion 314 of the adjusting element 31 is brought to engage with the second positioning portion 32c2 of the positioning sleeve 32, and the ejector is switched to the second operating state and maintains in this operating state. After the actuator 4 is actuated again, the positioned portion 314 of the adjusting element 31 is brought to engage with the first positioning portion 32c1 of the positioning sleeve 32, and the ejector is switched to the first operating state and maintains in this operating state. Such cycle could make the ejector to switch between the first operating state and the second operating state.

(iii) It can be understood that in the solutions exemplified in the detailed embodiments, as long as the actuator 4 is actuated once, the ejector can not only switch the operating state, but also use its own mechanical structure to maintain this operating state, thus saving the energy consumption required to maintain the operating state.

Nevertheless, other alternatives are conceivable, such as omitting the positioning sleeve 32 and the cam sleeve 34, a plurality of positioning holes are formed on the adjusting element 31, and a positioning pin that can be actuated by another actuator is provided. When the adjusting element 31 is located at an axial position, the positioning pin is controlled to engage with the corresponding positioning hole, thereby the adjusting element 31 is located at this axial position.

(iv) Although the actuator 4 is a solenoid valve in the detailed embodiments, the present disclosure is not limited to this, and the actuator 4 may be other power source such as a motor.

(v) The housing of the ejector for fuel cell of the present disclosure may be integrated as described above, or has independent separate parts which are fixed together. Specifically, when having independent separate parts, the housing could be divided into any number of independent separate parts as required, and then these independent separate parts are assembled and fixed together to form the housing. For example, the Venturi section and the mount section are formed independently according to the function, and then the venturi section and the mount section are fixed together to form the housing of the ejector for fuel cell by some connecters.

(vi) In addition, although it is described that one end of the elastic member 33 abuts against the nozzle 2, the present disclosure is not limited to this. For example, at the mounting section 12, the housing 1 may be formed with an abutted portion protruding toward the inner side in the radial direction, and one end of the elastic element 33 may abut against such abutted portion. In this way, the same function can be achieved.

(vii) It is understood that when the structure of the ejector of prior art can be adjusted steplessly according to the pressure of the contraction section, if the temperature of the working environment is too low, the mechanical structure may be frozen and may not work properly, the ejector is very unstable during the startup and shutdown phases with lower new fuel gas flow. In contrast, since the ejector for fuel cell of the present disclosure does not need to move during the startup and shutdown phases, the above problems would not occur.

(viii) Although not specifically stated, the fuel cell of the present disclosure could be, but is not limited to be, used in pure electric vehicles or hybrid vehicles.

1. An ejector for a fuel cell, comprising:
a housing, including a Venturi section formed with a contraction section, a throat section and a diffusion section that are sequentially arranged and in communication from one side to another side of the Venturi section in an axial direction of the housing, the housing also including a first inlet through which new fuel gas is communicated into the housing and a second inlet through which recycled fuel gas is communicated into the housing;
a nozzle, which is located inside the housing and is fixed to the housing, the nozzle having a tapered portion extending into the contraction section, the tapered portion and the contraction section being in shape-fit and spaced apart from each other in a radial direction of the housing, and a first passage being formed inside the nozzle, a second passage being formed between the nozzle and the contraction section, wherein the first inlet in communication with the throat section via the first passage, and the second inlet is in communication with the throat section via the second passage; and
an adjusting device, which is at least partially located inside the housing and is located at one side of the nozzle in the axial direction, the adjusting device including an adjusting element extending into the nozzle, wherein the adjusting element is configured to be located at different axial positions, and a cross-sectional area of at least a part of the first passage is different when the adjusting element is located at the different axial positions.

2. The ejector for the fuel cell according to claim 1, wherein the adjusting element has a tip formed in a tapered shape, an axial length of the tip extending into the nozzle is different when the adjusting element is located at the different axial positions.

3. The ejector for the fuel cell according to claim 1, wherein the adjusting device further includes a positioning sleeve located inside the housing and fixed to the housing, wherein the positioning sleeve includes positioning portions corresponding to the different axial positions, and the adjusting element includes positioned portions that are engageable with the positioning portions, so that when the positioned portions are engaged with the positioning portions, the adjusting element is located at corresponding axial positions.

4. The ejector for the fuel cell according to claim 3, wherein an axial end of the positioning sleeve facing the nozzle includes a plurality of first guide surfaces extending in a circumferential direction of the positioning sleeve,
wherein the positioning portions are provided at circumferential ends of the first guide surfaces or at either side in the circumferential direction relative to the first guide surfaces, and wherein the positioning portions have first positioning portions and second positioning portions alternately arranged in the circumferential direction, so that the positioned portions are configured to be guided by the first guide surfaces to engage with the first positioning portions or the second positioning portions.

5. The ejector for the fuel cell according to claim 4, wherein the adjusting device further includes an elastic element and a cam sleeve,
wherein one end of the elastic element abuts against the housing or the nozzle, and another end of the elastic element abuts against the adjusting element, so that the elastic element exerts elastic force on the adjusting element,
wherein an axial end of the cam sleeve facing the nozzle includes a plurality of second guide surfaces extending in the circumferential direction, wherein the cam sleeve is movable relative to the positioning sleeve in the axial direction, so that the cam sleeve is movable against the positioned portions to the corresponding axial positions where the second guide surfaces and the first guide surfaces are aligned or the second guide surfaces are closer to the nozzle relative to the first guide surfaces, wherein after being disengaged from the first positioning portions, the positioned portions are configured to rotate relative to the positioning portions and are guided to the first guide surfaces corresponding to the second positioning portions under the elastic force.

6. The ejector for the fuel cell according to claim 5, wherein axial ends of the positioned portions away from the nozzle have guided surfaces which are in shape-fit with the first guide surfaces and the second guide surfaces.

7. The ejector for the fuel cell according to claim 5, wherein the adjustment element further includes an inner cylinder extending into the cam sleeve, so that the adjusting element is supported by the cam sleeve.

8. The ejector for the fuel cell according to claim 5, wherein the cam sleeve is fixed relative to the positioning sleeve in a circumferential direction of the housing.

9. The ejector for the fuel cell according to claim 5, further comprising an actuator, which is able to exert a force on the cam sleeve in the axial direction, so that the adjustment element is pushed by the cam sleeve to move against the elastic force.

10. A fuel cell, comprising:
an ejector including
a housing including a Venturi section, a first inlet through which new fuel gas is communicated into the housing, and a second inlet through which recycled fuel gas is communicated into the housing,
a nozzle located inside the housing and fixed to the housing, the nozzle having a tapered portion extending into the Venturi section, wherein a first passage is formed inside the nozzle and extending therethrough,
an adjusting device, which is at least partially located inside the housing and is located at one side of the nozzle in an axial direction of the housing, the adjusting device including an adjusting element extending into the first passage, wherein the adjusting element is configured to be located at different axial positions, and a cross-sectional area of at least a part of the first passage is different when the adjusting element is located at the different axial positions; and
an actuator fixed to the housing and configured to move the adjusting device to the different axial positions.

11. The fuel cell according to claim 10, wherein,
when a flow rate of a fuel gas flow passing through the first inlet of the ejector is less than a predetermined value, the adjusting element of the adjusting device of the ejector is located at a first axial position,
when the flow rate of the fuel gas flow passing through the first inlet of the ejector is greater than or equal to the predetermined value, the adjusting element is located at another axial position different from the first axial position,
when the adjusting element is located at the first axial position, the cross-sectional area of at least a part of the first passage is minimized by the adjusting element.

12. The ejector for the fuel cell according to claim 1, wherein:
when a flow rate of a fuel gas flow passing through the first inlet of the ejector is less than a predetermined value, the adjusting element of the adjusting device of the ejector is located at one axial position,
when the flow rate of the fuel gas flow passing through the first inlet of the ejector is greater than or equal to the predetermined value, the adjusting element is located at another axial position different from the one axial position,
wherein when the adjusting element is located at the one axial position, the cross-sectional area of at least a part of the first passage is minimized by the adjusting element.

13. The fuel cell according to claim 10, wherein the Venturi section includes a contraction section, a throat section and a diffusion section that are sequentially arranged and in communication from one side to another side of the Venturi section in the axial direction.

14. The fuel cell according to claim 13, wherein the tapered portion extends into the contraction section.

15. The fuel cell according to claim 13, wherein the tapered portion and the contraction section are in shape-fit and spaced apart from each other in a radial direction of the housing.

16. The fuel cell according to claim 13, wherein a second passage is formed between the nozzle and the contraction section, the second inlet being in communication with the throat section via the second passage.

17. The fuel cell according to claim 10, wherein the first inlet is in communication with the Venturi section via the first passage.

18. The fuel cell according to claim 10, wherein the adjusting element has a tip, an axial length of the tip extending into the first passage is different when the adjusting element is located at the different axial positions.

19. The fuel cell according to claim 10, wherein the adjusting device further includes a positioning sleeve located inside the housing and fixed to the housing, wherein the positioning sleeve includes positioning portions corresponding to the different axial positions, and the adjusting element is engageable with the positioning portions.

20. The fuel cell according to claim 19, wherein the adjusting device further includes:
a cam sleeve fixed to the positioning sleeve in a circumferential direction of the housing and moveable relative to the positioning sleeve in the axial direction, the cam sleeve being configured to rotate the adjusting element relative to the positioning sleeve such that the adjusting element engages corresponding positioning portions; and
an elastic element arranged between the adjusting element and the nozzle, the elastic element being configured to bias the adjusting element towards the positioning sleeve.
